(19) United States
(12) Patent Application Publication
(10) Pub. No.: US 2005/0237698 A1
(43) Pub. Date: Oct. 27, 2005

(54) Reduced ESR through use of multiple wire anode

(76) Inventors: Bradley Ryan Postage, Findlay, OH (US); Jeffrey P. Poltorak, Greer, SC (US); James Charles Marshall, Simpsonville, SC (US)

Correspondence Address: John B. Hardaway, III;NEXSEN PRUET, LLC, P. O. Box 10107, Fed. Sta., Greenville, SC, 29603-0107, US

(21) Appl. No.: 10/830,616

(22) Filed: Apr. 23, 2004

(51) Int. Cl. H01G 9/00

(52) U.S. Cl. 361/533

(57) ABSTRACT

The ESR of a solid electrolytic capacitor can be decreased by using more than one anode lead or by using an anode lead with a cross-section which is oval or rectangular so as to increase contact area between anode lead and anode compact and reduce the resistance of the lead. The preferred anode is Ta and the preferred wire is Ta.

### BACKGROUND OF THE INVENTION

1. Field of the Invention

This invention relates to fabrication methods and constructions for solid electrolytic capacitors to reduce equivalent series resistance and improve performance.

2. Background and Prior Art

Anodes for capacitors are commonly made using valve metal compacts which are sintered to obtain porous metallurgical compacts having large surface areas. Tantalum is a preferred value metal. Prior to compaction, a wire, typically a tantalum wire, is inserted into the powder and held in place. The wire also may be welded to the anode body after compaction.

The process for formation of sintered tantalum anodes is described in U.S. Pat. Nos. 6,224,990; 6,319,459; and, 6,375,710, all assigned to the assignee of this invention. Tantalum anodes are prepared using powders of 0.2 microns and smaller to yield a product with a surface area approaching 1 square meter per gram and achieve a CV of between 20,000 (higher voltage product typically) and 150,000, microcoulombs per gram (CV/g) and are constantly trending higher

The powders are blended with a binder, pressed to form a compact from which the binder is removed by heating in a partial vacuum or washing with hot solvent.

The preferred method for connecting a wire to the anode—the anode lead—is to have a wire in place when the compact is pressed. This allows the anode lead to pass through most of the length of the anode compact and maximize contact area between a solid wire anode lead, usually Ta wire for a Ta anode. The compact, after removal of binder, is sintered at ca. 1380° C. The area of contact between wire and anode compact is limited by the diameter of the wire which is a function of the thickness of the compact. As the contact area between wire and anode compact decreases, the resistance at the point of contact is increased. As the wire gauge is increased, the internal resistance in the wire is increased. Both increases result in higher equivalent series resistance—ESR—which diminishes the performance of the capacitor.

The need exists for methods to decrease ESR while using smaller and thinner anode compacts. This is especially desirable in the Ta system.

### BRIEF SUMMARY OF THE INVENTION

It is a first objective of this invention to minimize the resistance within the anode wire between anode compact and the point of connection to the circuit in which the capacitor is used. It is a second objective of this invention to reduce the resistance at the contact between anode lead and sintered anode compact. It is a third objective of this invention to minimize the effective distance between the anode lead and the oxide layer on an anodized Ta compact which serves as the insulating layer of the capacitor.

These and other objects may be obtained by increasing the effective thickness of the anode lead and by increasing the contact area between anode lead and anode compact through the use of two or more anode leads. The same effect may be obtained also by using a “flat wire” anode lead which is a lead having an oval, elliptical or any other shape in which there are two different radii demonstrated or by using an anode lead which has a rectangular cross-section.

### BRIEF DESCRIPTION OF THE DRAWINGS

FIG. 1A is a plan view of a single anode lead according to the prior art.

FIG. 1B is a cross-section of FIG. 1A along lines A-A.

FIG. 2A is a plan view of a dual anode lead capacitor anode.

FIG. 2B is a cross-section of FIG. 2A along line B-B.

FIG. 3A is a plan view of a triple anode lead capacitor anode.

FIG. 3B is a cross-section of FIG. 3A along lines C-C.

FIG. 4A is a plan view of a flat wire anode lead for a capacitor anode.

FIG. 4B is a cross-section of FIG. 4A along line D-D.

### DETAILED DESCRIPTION OF THE INVENTION

The anode of a typical solid electrolytic capacitor consists of a porous anode body, with a lead wire extending beyond the anode body and connected to the positive mounting termination of the capacitor. The anode is formed by first pressing a valve metal powder into a pellet. Valve metals include Al, Ta, Nb, Ti, Zr, Hf., W, and mixtures, alloys, suboxides of these metals. The anode is sintered to form fused connections between the individual powder particles. There are several resistances to current flow in the anode portion of a solid electrolytic capacitor. The current must flow from the positive mounting termination to the lead wire attached to or imbedded in the anode body. Current flows through the portion of the anode lead which extends outside the body of the anode. The current flow through the positive termination and the anode lead produce series resistances which contribute to the equivalent series resistance (ESR) of the finished device. Resistances inside the body of the anode generate parallel resistances which also contribute to the ESR of the finished device. The current travels from the point of lead wire egress to the anode body to all points of the anode body through the path(s) of least resistance. The current must pass from the lead wire into the anode body through points of contact between the lead wire and the particles which make up the porous anode body. The current must then travel through the porous anode body, through small necks of the sintered particles which make up the anode body.

Resistance in the lead wires and in the anodes body is governed by the general equation for resistance.
Resistance=resisitivity×path length/cross sectional area.

Increasing the cross sectional area available for current flow reduces the resistance as indicated by the equation above. The maximum diameter of the lead wire is determined by the dimensions of the anode. The lead wire diameter can not be greater than the thickness of the anode (t in the figures). Thus the maximum cross sectional area for current to flow through a single cylindrical lead wire is πt²/4. For a given wire diameter the maximum cross-sectional area for current flow increases proportionately to the number of lead wires connecting the anode body to the positive mounting termination. The cross-sectional area can also be increased by using lead wires which are not cylindrical, for example flat or ribbon wire. Thus by increasing the number of wires or utilizing flat lead wires the resistance in the connection between the positive mounting termination and the anode body is reduced.

The resistance for current to flow is lower in the solid lead wire than the porous anode body due to the lower cross sectional area for current flow in a porous body than a solid wire. Although the lead wire(s) can be attached to the anode body, for example by welding to the top of the body, imbedding the lead wire(s) in the anode body reduces the resistance for current to flow. For lead wires which extend into the porous anode body the cross sectional area available for current to flow from the lead wire to the body is proportional to the external surface area of the lead within the body of the anode.

Maximum Area is proportional to π×t×l (for single cylindrical lead wires).

The cross sectional area for this resistance term can be increased by increasing the number of lead wires or utilizing lead wires which are not cylindrical.

The path length for current to flow from the lead wire to points of the anode body which are the greatest distance from the lead wire is reduced by utilizing multiple lead wires or non-cylindrical lead wires, for example, flat or ribbon lead wire.

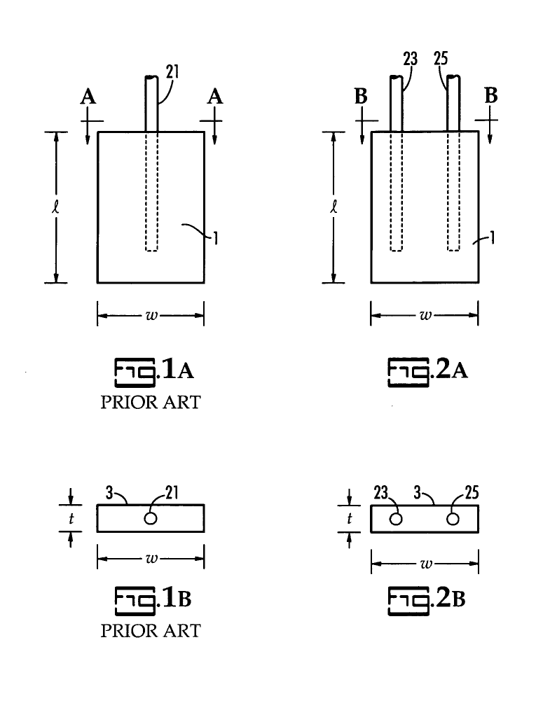

FIGS. 1A and 1B illustrate prior art anodes with lead wire attached. A sintered valve metal compact 1, preferably Ta has embedded therein a solid wire 21, also preferably Ta. The compact 1 in plan view has a length l in proportion to a width w. When viewed along line A-A, it is shown to have a head surface 3 and a thickness t. The lead wire 21 is circular in cross-section and must be of a diameter less than the thickness t of the compact.

FIGS. 2A and 2B illustrate a first embodiment of this invention. Compact 1 has two anode leads, 23 and 25 embedded therein. When viewed along line B-B, it is seen that with the same thickness t, the area of contact between the anode leads 23, 25 and the compact 1 has been doubled and the effective cross-sectional area of the anode lead likewise has been doubled.

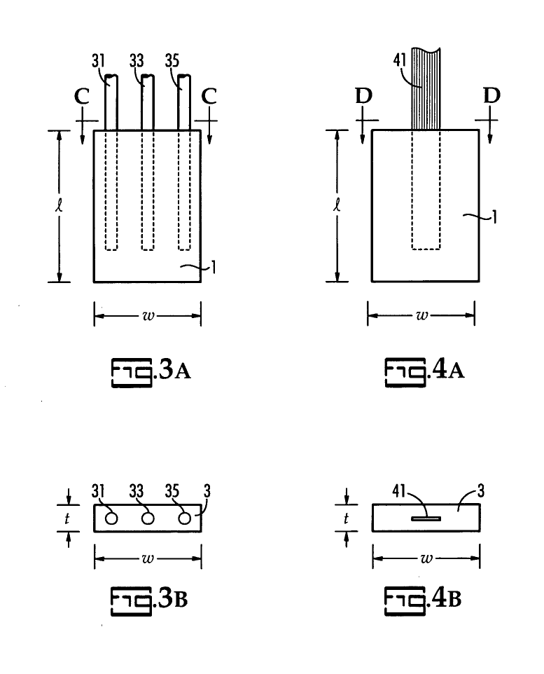

FIGS. 3A and 3B illustrate a second embodiment of the invention. Three anode leads 31, 33, 35 are used, tripling the contact area and effective cross-sectional area of the anode leads.

FIG. 3B illustrates one limitation in the invention, viz., the number of additional anode leads which may be used. Both spatial and manufacturing issues arise, which impose practical limitations. An alternative is the use of “oval” or “flat” wires. A single flat ribbon can be inserted in the metal powder before formation of the green stage in the same manner as a single wire is handled in the prior art. A single, essentially rectangular, cross-section wire is shown as 41 in FIGS. 4A and 4B as illustrative of the alternative approach. The actual shape of the wire and the thickness and width thereof can be varied. Grooves may be formed in the top and bottom (wide) surface of the ribbon wire for increased surface area.

### INDUSTRIAL UTILITY

The multiple anode leads and “flat” wire anode lead reduce ESR of capacitors, enabling improved performance in electronic devices.

The invention has been described in terms of certain preferred embodiments. Modification of details of the invention which do not depart from the concept disclosed herein and which would be obvious to those with skill in the art of capacitor design are included within the scope and spirit of the invention.

1. An anode for a capacitor having one anode terminal and one cathode terminal comprising a sintered valve metal compact and more than one anode lead wire.

2. An anode according to claim 1 wherein the valve metal is selected from the group consisting of Al, Ta, Nb, Ti, Zr, Hf, W and mixtures, alloys and suboxides thereof.

3. An anode according to claim 1 wherein the more than one anode lead wire is selected from the group consisting of Al, Ta, Nb, Ti, Zr, Hf, W and mixtures, alloys and suboxides thereof.

4. An anode according to claim 1 wherein the more than one anode lead wire has a circular cross-section.

5. An anode for a capacitor having one anode terminal and one cathode terminal comprising a sintered valve metal compact and an anode lead wire which has a non-circular cross-section.

6. An anode lead wire according to claim 5 wherein said non-circular cross-section is an oval.

7. An anode lead wire according to claim 5 wherein said non-circular cross-section is an ellipse.

8. An anode lead wire according to claim 5 wherein said non-circular cross-section is substantially flat.

9. A capacitor having one anode terminal and one cathode terminal comprising:
a) an anode compact formed from a sintered valve metal powder;
b) at least two solid conductor anode lead wires embedded into said anode compact;
c) a dielectric formed upon the surface of the anode compact to;
d) a conductive material in contact with said dielectic to form a cathode.
e) terminal connected to said cathode to form a cathode terminal; and
f) a capsule formed around the anode and cathode exposing only the respective anode and cathode terminals.

10. A capacitor according to claim 9 wherein said valve metal is selected from Al, Ta, Nb, Ti, Zr, Hf, W and mixtures, alloys and suboxides thereof.

11. A capacitor according to claim 9 wherein said at least two anode lead wires are selected from the group consisting of Al, Ta, Nb, Ti, Zr, Hf, W and mixtures, alloys and suboxides thereof.

12. A capacitor having one anode terminal and one cathode terminal comprising:
a) an anode compact formed from a sintered valve metal powder;
b) at least one solid conductor anode lead wire having a non-circular cross-section embedded into said anode compact;
c) a dielectric formed upon the surface of the anode compact;
d) a conductive material in contact with said dielectic to form a cathode.
e) a terminal connected to said cathode to form a cathode terminal; and
f) a capsule formed around the anode and cathode exposing only the respective anode and cathode terminal.

13. A capacitor according to claim 12 wherein said valve metal is selected from the group consisting of Al, Ta, Nb, Ti, Zr, Hf, W and mixtures, alloys and suboxides thereof.

14. A capacitor according to claim 12 wherein said at least one anode lead wire is selected from the group consisting of Al, Ta, Nb, Ti, Zr, Hf, W and mixtures, alloys and suboxides thereof.

15. In a capacitor having a sintered valve metal anode, a dielectric layer formed upon said anode, a cathode layer in contact with said dielectric layer formed upon said anode, a single anode terminal and a single cathode terminal, the improvement comprising the use of more than one anode lead wire.

16. In a capacitor having a sintered valve metal anode, a dielectric layer formed upon said anode, a cathode layer in contact with said dielectric layer formed upon said anode, a single anode terminal and a single cathode terminal, the improvement comprising use of an anode lead wire having a non-circular cross-section.

17. In a capacitor according to claim 16, the improvement comprising use of a substantially flat anode lead wire.

18. In a capacitor according to claim 16 the improvement comprising use of an elliptical or oval anode lead wire.
